(19) United States
(12) Patent Application Publication
(10) Pub. No.: US 2018/0262256 A1
(43) Pub. Date: Sep. 13, 2018

(54) SPACE-FREQUENCY CONVERTING MULTI-ANTENNA TRANSCEIVER

(71) Applicant: Telefonaktiebolaget LM Ericsson (publ), Stockholm (SE)

(72) Inventors: Mats RYDSTRÖM, Billdal (SE); Peter HEDSTRÖM, Lerum (SE); Ulf HILL, Kista (SE)

(21) Appl. No.: 15/761,974

(22) PCT Filed: Oct. 13, 2015
(86) PCT No.: PCT/EP2015/073657

§ 371 Date: Mar. 21, 2018

(51) Int. Cl. H04B 7/08; H04B 1/713

(52) U.S. Cl. CPC H04B 7/08; H04B 1/713

(57) ABSTRACT

It is provided a receiver arrangement for receiving information from a remote transmitter via a wireless signal S1. The receiver arrangement includes first and second spatially separated antennas operatively connected to a central receiver unit. The first antenna being connected to the central receiver unit via a first transceiver unit. The first transceiver unit receiving the signal S1 via the first antenna, and converting the received signal into a second signal S2 separable from the received signal S1, and transmitting the second signal S2 wirelessly to the central receiver unit. The central receiver unit is configured to receive the signal S1 via the second antenna, and to receive the second signal S2 from the first transceiver unit, and to obtain information comprised in S1 based on the signals received via the first and second antennas. Related transmitter arrangements and methods for transmission are disclosed.

### TECHNICAL FIELD

The present disclosure relates to receiver, transmitter and transceiver arrangements in communication systems.

### BACKGROUND

A transmitted signal in wireless communication systems is susceptible to many different sorts of distortion, such as fading, interference, dispersion effects, path loss effects etc. In addition to the various forms of distortion, the often limited bandwidth availability must be taken into account when considering how to design a wireless communication system which offers both spectral efficiency and robust transmission.

To overcome some of the above problems, and to increase throughput to accommodate increasing data rate requirements, it is increasingly popular to use multiple-antenna systems. Multi-antenna systems can be Single Input Multiple Output (SIMO) where multiple receive antennas receive a signal transmitted from a single transmit antenna, or Multiple Input Single Output (MISO), where a single receive antenna receives a signal transmitted by multiple transmit antennas, or Multiple Input Multiple Output systems (MIMO) where multiple transmit antennas are used to transmit a signal to multiple receive antennas.

An important issue to consider when designing multi-antenna systems is the relative placement of antennas, i.e., the relative antenna geometry. For instance, the antennas in a MIMO receiver system are preferably placed at a specific distance from each other, where the preferred distance is dependent on the carrier signal frequency, the distance between transmitter and receiver, and the placement of transmit antennas. This is especially true for the type of MIMO systems referred to as Line-Of-Sight MIMO where the system does not function properly unless a given relative antenna placement is achieved. Another example of preferred antenna placement is a diversity receiver arrangement (SIMO), where the receive antennas should be placed sufficiently far apart so as to provide for reduced correlation of fading between received signals, since otherwise no diversity reception is obtained.

These antenna placement considerations lead to geometrical constraints with regard to possible locations for the receiver and/or transmitter antennas, which constraints imply an increase in complexity and cost when installing the receiver and/or the transmitter. For commonly used frequencies and radio link distances, the preferred distance between antennas may be on the order of several meters up to tens of meters, making it difficult to find suitable installation locations, especially in an urban environment.

In view of the above, it is desirable to provide improvements for communication systems including multiple-antenna systems while maintaining the advantageous effects of a multiple-antenna system.

### SUMMARY

In view of above-mentioned and other drawbacks of the prior art, it is an object of the present technique to provide an arrangement reducing the complexity related to installation and configuration of multiple-antenna communication systems.

According to a first aspect, it is provided a receiver arrangement for receiving information from a remote transmitter via a wireless signal S1, the receiver arrangement comprising first and second spatially separated antennas configured to be operatively connected to a central receiver unit, the first antenna being configured to be operatively connected to the central receiver unit via a first transceiver unit, the first transceiver unit being configured to receive the signal S1 via the first antenna, and to convert the received signal into a second signal S2 separable from the received signal S1, and to transmit the second signal S2 wirelessly to the central receiver unit. The central receiver unit is further configured to receive the signal S1 via the second antenna, and to receive the second signal S2 from the first transceiver unit, and to obtain information comprised in S1 based on the signals received via the first and second antennas.

The technique disclosed herein is based on a realization that the transmission of a received signal, from a transceiver unit in a communication system to a central receiver unit, can be performed wirelessly by converting the originally received signal into a new signal which is separable from the original signal. Thereby, antennas in a multiple antenna system can communicate with a central receiver unit without the need for cabling between different units in a combined receiver arrangement, and without interfering with the wireless signal S1.

According to some aspects, the receiver arrangement further comprises a second transceiver unit, wherein the second antenna is configured to be operatively connected to the central receiver unit via the second transceiver unit. The second transceiver unit is further configured to receive the signal S1 via the second antenna, and to convert the received signal into a third signal S3 separable from the received signal S1 and from the second signal S2, and to transmit the third signal S3 wirelessly to the central receiver unit.

Hereby, the central receiver unit does not have to be positioned so as to be able to receive the wireless signal S1 directly. It is sufficient if the central receiver unit is located where it can receive signals S2 and S3. Thus, deployment of the central receiver unit is simplified in that additional placement options may become feasible.

According to some aspects, the central receiver unit is further configured to convert the second signal S2 into a signal S1A1 corresponding to the signal S1 received via the first antenna and to obtain the transmitted information using the signal S1A1 and the signal S1 received via the second antenna, S1A2.

Hereby, the central receiver unit mimics a receiver unit having a connection by cable to the first and second spatially separated antennas, since the signals S1A1 and S1A2 correspond to signals that would have been received over said cables. Consequently, legacy receiver modules adapted for operation with a receiver unit connected by cable to antennas can be re-used.

According to some aspects, the central receiver unit is co-located with a transmission unit configured to transmit a signal S_{T} to a remote receiver. The central receiver unit is further configured to subtract the signal S_{T} from the received signal S2, and wherein the signal S_{T} is transmitted in an at least partly overlapping frequency band as the signal S2.

Hereby, the amount of additional communications resources needed for transmission of the signal S2 is reduced, since signal S2 at least partly shares communication resources with transmitted signal S_{T}.

According to some aspects, a signal power of transmission of the second signal S2 and/or the third signal S3 is lower than a signal power of transmission of the wireless signal S1.

Hereby, interference to other communication systems generated from the transmission of the second signal S2 and/or the third signal S3 is reduced. Consequently, frequency resource re-use is facilitated.

According to some aspects, the first transceiver unit comprises a signal converter configured to convert the first signal S1 occupying a first frequency band f1 into a second signal S2 occupying a second frequency band f2, wherein the first frequency band f1 and the second frequency band f2 are non-overlapping in frequency.

Hereby, the second signal S2 can be separated from the wireless signal S1 by straightforward filtering techniques.

According to some aspects, the first transceiver unit comprises a signal converter configured to convert the first signal S1 into a second signal S2 having a frequency spreading code different from a frequency spreading code of the first signal.

Hereby, no additional frequency resources are consumed by the second signal S2, since wireless signal S1 and signal S2 may share the same frequency resource.

The object stated above is further obtained by a transmitter arrangement for transmitting information via a wireless first signal S1 to be received by a remote receiver. The transmitter arrangement comprises first and second spatially separated antennas configured to be operatively connected to a central transmitter unit. The first antenna is operatively connected to the central transmitter unit via a first transceiver unit and the central transmitter unit is arranged to convert a signal S_{T} into a second signal S2 separable from the signal S1, and to transmit the second signal S2 wirelessly to the first transceiver unit. The first transceiver unit is configured to receive the second signal S2, and to convert the signal S2 into a signal S1A1, and to transmit the signal as part of the wireless signal S1 to be received by the remote receiver via the first antenna, the central transmitter unit further being arranged to generate a signal SA2 from signal S_{T} and to transmit the signal S_{T} as part of the wireless signal S1 via the second antenna to be received by the remote receiver.

Hereby, in analogy to the receiver arrangements above, the need for cabling between central transmitter unit and antennas is reduces or eliminated. Consequently, the same advantages as mentioned above in connection to the receiver arrangement are obtained also at the transmitter side.

According to some aspects, the transmitter arrangement further comprises a second transceiver unit. The central transmitter unit being arranged to transmit a signal S1A2 via the second antenna as part of the signal S1 to be received by the remote receiver by converting the signal S_{T} into a third signal S3 separable from the signal S1 and from the signal S2, and to wirelessly transmit the third signal S3 to the second transceiver unit. The second transceiver unit is configured to receive the third signal S3, and to convert the signal S3 into the signal S1A2, and to transmit the signal S1A2 as part of the wireless signal S1 to be received by the remote receiver via the second antenna.

Hereby, as discussed above in connection to the receiver arrangements, the central transmitter unit does not have to be positioned so as to be able to transmit signals directly to the remote receiver. It is sufficient if the central transmitter unit is located such that it can reach the first and second transceiver units. Thus, deployment of the central transmitter unit is simplified in that additional placement options may become feasible.

According to some aspects, a signal power of transmission of the wireless signal S1 is higher than a signal power of transmission of the second signal S2 and/or the third signal S3.

Hereby, interference to other communication systems generated from the transmission of the second signal S2 and/or the third signal S3 is reduced. Consequently, frequency resource re-use is facilitated.

The object stated above is further obtained by a method for transmission in a multiple-antenna receiver arrangement for a wireless communication system. The method comprises receiving, by a first antenna in a first transceiver unit, a first signal S1 transmitted from a remote transmitter, converting the received signal S1 into a second signal S2 separable from the first received signal S1, wirelessly transmitting the second signal S2 to a central receiver unit, receiving, by a second antenna in the central receiver unit, a first signal S1 transmitted from a remote transmitter, and in the central receiver unit, obtaining information comprised in S1 based on the signals received via the first and second antennas.

According to some aspects, the step of converting comprises frequency shifting the first received signal S1 occupying a first frequency band f1 such that the signal S2 occupies a second frequency band f2 which is non-overlapping with the first frequency band f1.

According to some aspects the step of converting comprises changing a frequency spreading code of the first received signal S1 into a frequency spreading code for the second signal S2 different from a frequency spreading code of the first signal S1.

The object stated above is further obtained by a multiple-antenna receiver arrangement for a wireless communication system comprising means for receiving, by a first antenna in a first transceiver unit, a first signal S1 transmitted from a remote transmitter, means for converting the received signal S1 into a second signal S2 separable from said first received signal S1 means for wirelessly transmitting said second signal S2 to a central receiver unit; means for receiving, by a second antenna in the central receiver unit, a first signal S1 transmitted from a remote transmitter; and in the central receiver unit, means for obtaining information comprised in S1 based on the signals received via the first and second antennas.

There is also provided a communication system for transmitting information via a wireless signal S1, comprising a receiver arrangement according to any one of the above described aspects, and a transmitter arrangement according to any one of the above described aspects.

The methods, multiple-antenna receiver arrangements, and communication systems disclosed herein all display advantages corresponding to the advantages already mentioned in relation to the receiver and transmitter arrangements above.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

The invention is now described, by way of example, with reference to the accompanying drawings, in which:

FIG. 1 is a schematic illustration of a multiple-antenna receiver arrangement according to embodiments of the present technique;

FIG. 2 is a schematic illustration of a multiple-antenna receiver arrangement according to embodiments of the present technique;

FIG. 3 is a schematic illustration of a multiple-antenna receiver arrangement according to embodiments of the present technique;

FIG. 4 is a schematic illustration of a multiple-antenna transmitter arrangement according to embodiments of the present technique;

FIG. 5 is a schematic illustration of a multiple-antenna transmitter arrangement according to embodiments of the present technique;

FIG. 6 is a schematic illustration of a multiple-antenna transceiver arrangement according to embodiments of the present technique;

FIG. 7 is a flow-chart outlining the general features of a method according to an embodiment of the present technique; and

FIGS. 8A-D are flow charts outlining general features of methods according to embodiments of the invention.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

In the following detailed description, various embodiments of receiver, transmitter and transceiver arrangements will be described, mainly with reference to arrangements for use in multiple-antenna radio frequency (RF)-communication systems, such as MIMO-systems. Even though the examples presented herein mainly relate to dual-antenna systems, it should be understood that the principles described herein are applicable to multiple-antenna systems comprising any number of receiving or transmitting antennas.

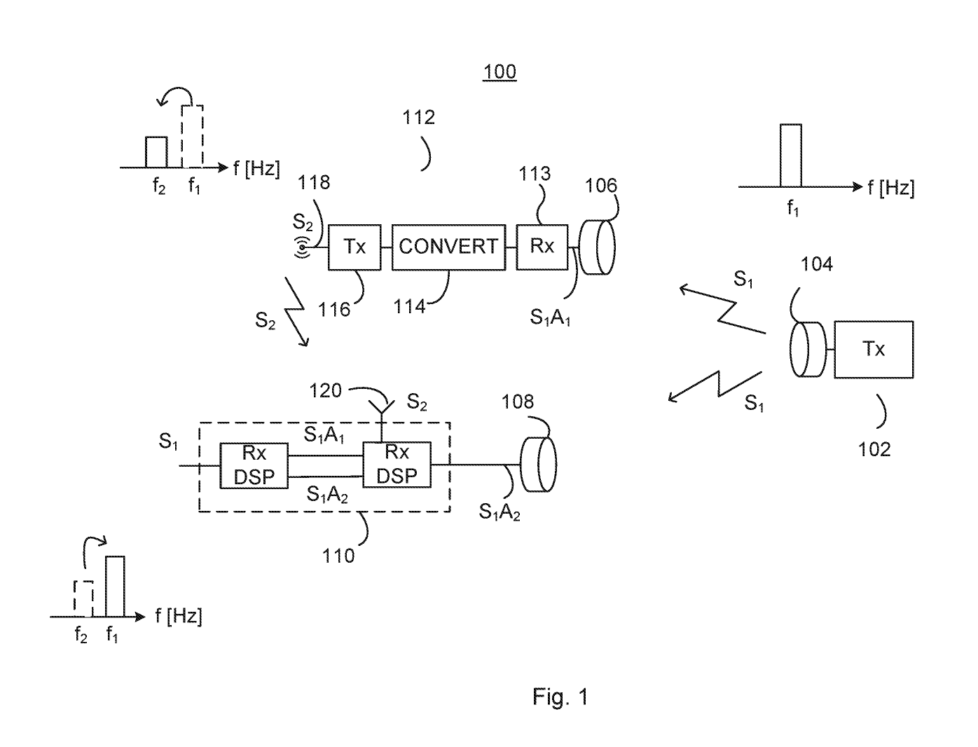

FIG. 1 schematically illustrates a multiple-antenna receiver arrangement 100 for receiving information from a remote transmitter 102. The remote transmitter 102 wirelessly transmits a signal S1 via a transmitting antenna 104. The receiver arrangement comprises first and second spatially separated antennas 106, 108, configured to be operatively connected to a central receiver unit 110. The first antenna 106 is operatively connected to the central receiver unit 110 via a first transceiver unit 112. The first transceiver unit comprises a receiver 113, a signal converter 114 and a transmitter 116 having a transmitting antenna 118. Furthermore, the first transceiver unit 112 is configured to receive the signal S1 via the first antenna 106 and to convert the received signal into a second signal S2 separable from the received signal S1, and to transmit the second signal S2 wirelessly to the central receiver unit 110 via the transmitting antenna 118.

Herein, that the antennas are configured to be operatively connected to a central receiver unit means that an information signal may pass between antennas and the central receiver unit. Hence, operatively connected may refer to connection by cable, or connection by part cable and part wireless link. Both options are illustrated in FIG. 1 where the first antenna is operatively connected to the central receiver unit by part cable and by part wireless link, while the second antenna is operatively connected to the central receiver unit by cable only.

The central receiver unit 110 may further comprise a third receiving antenna 120 for receiving the second signal S2. The central receiver unit 110 is thus configured to receive the signal S1 via the second antenna 108, and to receive the second signal S2 from the first transceiver unit 112 via the third receiving antenna 120 and to obtain information comprised in S1 based on the signals received via the first and second antennas (104, 106). Thus, because the central receiver unit 110 is operatively connected to the antennas 106, 108, it is able to receive the signal S1 indirectly via the first antenna o16 as the second signal S2, and more directly via the second antenna o18, without intermediate signal conversion.

A signal S1 comprising certain information is transmitted from the transmitter 102. However, since the signal is received by the two spatially separated different antennas 106, 108, the signal S1 can be considered to have propagated along different propagation channels thereby having different characteristics, hence the distinction between the signal received by the first antenna, S1A1, and the signal received by the second antenna, S1A2. Thus, the characteristics of the two received signals may be different. For example, the two received signals may have different phase, or the attenuation due to fading of the two signals may be different. However, based on the two signals received by the first and second antennas 106, 108, the central receiver unit 110 can obtain the information comprised in S1 more robustly than if only a single antenna was used for reception.

Through the use of a multiple-antenna receiver arrangement, it is possible to recover the information of the originally transmitted signal S1 even if the signal quality have deteriorated during the propagation of the signals to the degree that only one of the signals would not be sufficient to obtain the information.

Moreover, by means of the above described receiver arrangement 100, a signal received at a location spatially separated from the central receiver unit 110 can be wirelessly transmitted to the central receiver unit 110 by converting the signal into a second signal separable from the first signal, and by wirelessly transmitting the signal to the central receiver unit 110. Thereby, since the signal S2 is separable from S1, the central receiver unit 110 can receive and obtain the signal S2 separate from the signal S1A2 received by the second antenna 108. Since it is assumed that the manner of conversion performed in the first transceiver unit 112 is known, the central receiver unit can, if needed recreate the signal S1A1 or at least a signal corresponding to the signal S1A1, and based on the signals S1A1 and S1, information comprised in S1 can be obtained based on known signal processing techniques.

By means of the antenna arrangement described above, the need for cabling between the first receiving antenna 106 and the central receiving unit 110 is reduced or even eliminated. Thereby, the deployment of multi-antenna systems can be simplified allowing for more flexibility when deploying antennas, e.g. by making it easier to find suitable antenna locations, which in turn leads to improved system performance.

It is noted in FIG. 1 that the antennas 106, 108 as well as the central receiver unit 110 are co-located in the sense that they form part of the same multiple-antenna receiver arrangement 100 and are deployed within a limited range of each other. Thus, the arrangement illustrated in FIG. 1 is different from a communication system where a relay transceiver has been deployed to relay transmission of signal S1 from a transmitter to a receiver. Such a communication system comprising a relay would not solve the problems considered herein.

That the signal S2 is separable from the signal S1 should be interpreted to mean that it is possible to entirely separate the two signals in order to recover the original signals in a receiver receiving both of the signals. The signal S1 is thus converted to S2 to avoid mixing of the two signals. In other words, since the two signals are separable, there is no or little interference between them when received at the central receiver unit.

As outlined in FIG. 1, the signal S1, according to aspects, occupies a first frequency band f1. Moreover the signal S1 received by the first antenna 106, referred to as S1A1, can be frequency shifted by the converter 114 to occupy a second frequency band f2, which is non-overlapping in frequency with f1, thereby making the signal S2 separable from S1A2 received by the second antenna 108. Once the signal S2 is received by the central receiver unit 110, a reverse frequency shifting can be performed to obtain the signal S1A1 occupying the frequency band f1. This allows the second signal S2 to be separated from the wireless signal S1 by straightforward filtering techniques.

As an alternative to frequency shifting, a frequency spreading code of the signal can be changed so that the signal S2 has a frequency spreading code different from a frequency spreading code of S1, thereby making the signal S2 separable from S1A2. The central receiving unit can then de-spread S2 to recover the signal S1A1. Thereby, no additional frequency resources are consumed by the second signal S2, since the wireless signal S1 and the signal S2 may share the same frequency resource.

In the central receiver unit 110 illustrated in FIG. 1, the second antenna 108 receiving the signal S1 is illustrated as being separate from the third receiving antenna 120 receiving the signal S2. For example, the second antenna 108 can be a directional antenna configured and arranged to receive the signal S1 transmitted from the remote transmitter 102, and the antenna 120 for receiving S2 may be an omnidirectional antenna. However, second receiving antenna 108 and the third receiving antenna 120 can be integrated into a single antenna configured and arranged to receive both S1 and S2. Moreover, the transmitting antenna 118 of the first transceiver unit 112 can be an omnidirectional antenna or a directional antenna arranged and configured to transmit a signal to an antenna of the central receiving unit 110.

The central receiving unit 110 comprises one or more digital signal processing units DSPs, denoted Rx DSP. According to aspects, the Rx DSP comprises an RF analog to digital converter, RF-ADC, to sample the received signals directly at RF-frequencies without intermediate frequency conversion. Thereby, receivers based on digital RF are capable of sampling bandlimited signals over a very wide band, such as from DC to some 90 GHz and beyond. As it is foreseen that the cost of digital RF equipment will fall, as will the power consumption of devices featuring digital RF, digital RF is becoming feasible for use in communication equipment deployed in large scale networks. The present technique is therefore advantageously combinable with RF-ADC implementation.

As a further option to the specific frequency shifting described above, a digital-RF receiver may scan a wide frequency band in order to detect on-going communication, and set the antenna specific frequency offsets so as not to collide with on-going transmission. This feature is useful if no frequency slots are free for the links between the digital RF receiver and the frequency-converting receive antenna transceiver units. In this case the antenna specific frequency offsets or spreading codes are configurable as opposed by being pre-determined or hard-wired. According to aspects, the antenna specific frequency offsets or spreading codes can be re-configured over time to, e.g., match transmission time patterns in a network.

In the multiple-antenna receiver arrangement 100, the distance between the first antenna 106 and the second antenna 108 is, according to some aspects, advantageously selected for diversity reception based on a wavelength of a carrier of the first transmitted signal S1. Diversity reception is based on the concept that the antennas are positioned sufficiently far apart to reduce correlation between signals received at the different antennas. In particular, it is preferred to space receiving antennas for diversity reception far enough apart such that the fading experienced on the different antennas is different, i.e., not strongly correlated. One way to determine a suitable distance between antennas in a diversity reception system is to space antennas apart as function of wavelength, where wavelength refers to the wavelength of the carrier frequency of communication. Sometimes a fraction, e.g., half, of the wavelength is enough, and sometimes larger separation is needed.

In the multiple-antenna receiver arrangement 100, the distance between the first antenna 106 and the second antenna 108 is, according to some other aspects, advantageously selected for MIMO communication based on a wavelength of a carrier of the first transmitted signal S1, and on a relative geometry of the receiver antennas 106, 108 with respect to any antennas used for transmission of the signal S1.

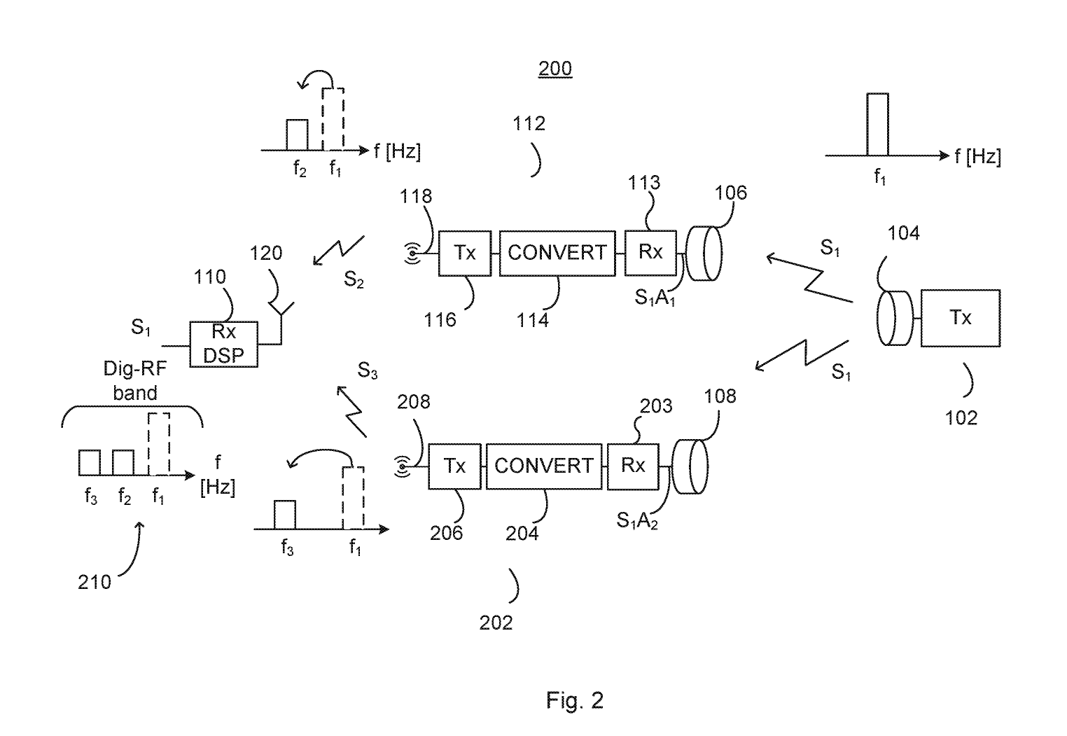

FIG. 2 schematically illustrates a receiver arrangement 200 further comprising a second transceiver unit 202. Here, the second antenna 108 is configured to be operatively connected to the central receiver unit 110 via the second transceiver unit 202. The second transceiver unit 202 is thereby configured to receive the signal S1 via the second antenna 108, and to convert the received signal into a third signal S3 separable both from the received signal S1 and from the second signal S2 transmitted by the first transceiver unit 112. The second transceiver unit further transmits the third signal S3 wirelessly to the central receiver unit 110. The second transceiver unit 202 is similar to the first transceiver unit, comprising a receiver 203 receiving the signal S1A2, a signal converter 204 for converting the signal S1A2 into the signal S3, and a transmitter 206 having an antenna 208 for transmitting the signal S3 to the central receiving unit. A difference between the first and second transceiver units 112, 202 lies in the signal converting units 114, 204 where each converting unit is configured to convert the received signal in a o10 transceiver specific manner such that the resulting signal is separable both from the transmitted signal S1 and from any converted signals formed by other transceiver units in the receiver arrangement. In FIG. 2, the second transceiver unit 202 is illustrated to frequency shift the received signal S1A2 into a signal S3 occupying a frequency band f3, different from and non-overlapping with each of f1 and f2. These frequency bands 210 are illustrated in FIG. 2. As mentioned above, transceiver units 112, 202 may also, according to aspects, apply different frequency spreading codes instead of or in addition to frequency shifting, to achieve separable signals S2 and S3. Such aspects are not shown in FIG. 2.

By means of the receiver arrangement 200 illustrated in FIG. 2, the received and converted signals S2 and S3 are both transmitted wirelessly to the central receiving unit 110 which means that the need for cabling between the receiving antennas 106, 108 and the central receiving unit is reduced or even eliminated. This simplifies deployment of a multiple-antenna receiver and also means that the central receiving unit need not be in line-of-sight (LoS) of the remote transmitter 102 since it is sufficient if the central receiver unit is located where it can receive signals S2 and S3. Accordingly, as an example, the receiving antennas 106,108 can be arranged at a roof of a building while the central receiver unit 110 can be arranged safely indoors or at ground level only requiring that the antenna 120 is arranged so as to receive the signals S2 and S3 transmitted by antennas 118 and 208, respectively.

Hereby, the central receiver unit 110 mimics a receiver unit having connection by cable to the first and second spatially separated antennas, since the signals S1A1 and S1A2 correspond to signals that would have been received over said cables. Consequently, legacy receiver modules adapted for operation with a receiver unit connected by cable to antennas can be re-used.

The advantages of eliminating the need for a wired connection between the transceiver units and the central receiver unit 110 are only increased with an increasing number of antennas in the multiple-antenna receiver arrangement.

A further advantage is that a signal power of transmission of the second signal S2 and/or the third signal S3 can be lower than a signal power of transmission of the wireless signal S1. When the signal S2 and/or the signal S3 is transmitted at low power, the interference generated by this transmission on other receivers is reduced compared to the case where they are transmitted at full power, i.e., at the signal power of transmission of the wireless signal S1. This means that an operator of a communications system having access to a range of frequency bands can allocate frequency bands for transmission of signals like signal S2 and signal S3 several times as long as the central receiver units are spaced far enough apart. The lower the power used for transmission, the smaller the distance between central receiver units. Also, a frequency band in use for communication of information such as the wireless signal S1 may be re-used for transmission of signals like signal S2 and signal s3 as long as receiver separation is large enough.

The above described receiver arrangements 100, 200, can advantageously form the basis of a modular receiver arrangement where additional transceiver units can be easily added as separate modules if required.

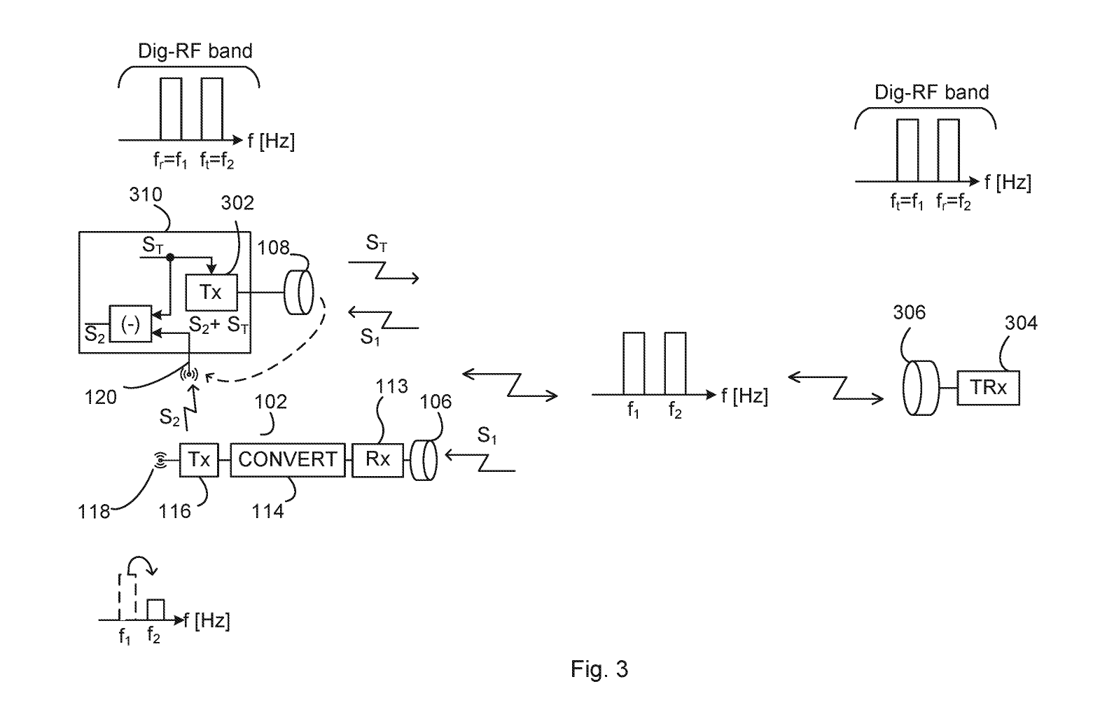

FIG. 3 is a schematic illustration of a receiver arrangement where a central receiver unit 310 is co-located with a transmission unit 302 configured to transmit a signal S_{T} to a remote receiver 304. The central receiver unit 310 is configured to subtract the signal S_{T} from a received signal S2+S_{T}, and the signal S_{T} is transmitted in an at least partly overlapping frequency band as the signal S2. As illustrated in FIG. 3, a first frequency band f1 is used for transmission from right to left, and a second frequency band f2 is used for transmission in the reverse direction. Note that fₜ denotes transmission frequency band and fᵣ denotes reception frequency band in FIG. 3. The left-most transceiver arrangement is equipped with one frequency converting transceiver unit 102. The transceiver unit 102 converts frequency band f1 into frequency band f2, i.e., into the transmit frequency band of the left-most transmitter 302. The left-most central receiver unit 310 will then receive a sum of the transmit signal S_{T} and the transmit signal S2 from the transceiver unit 102. However, since the transmit S_{T} signal is known, this self-interference can be processed in order to recover the signal S2 from the sum S_{T}+S2.

An advantage of aspects illustrated in FIG. 3 is that the frequency band fₗ used for transmission from left to right in FIG. 3 is re-used by the transceiver 102 to transmit the signal S2 to the central receiver unit 310. Consequently, no additional frequency resources are consumed by the transmission of signal S2 other than the frequency resources already allocated for transmission to the right-hand side transceiver 304.

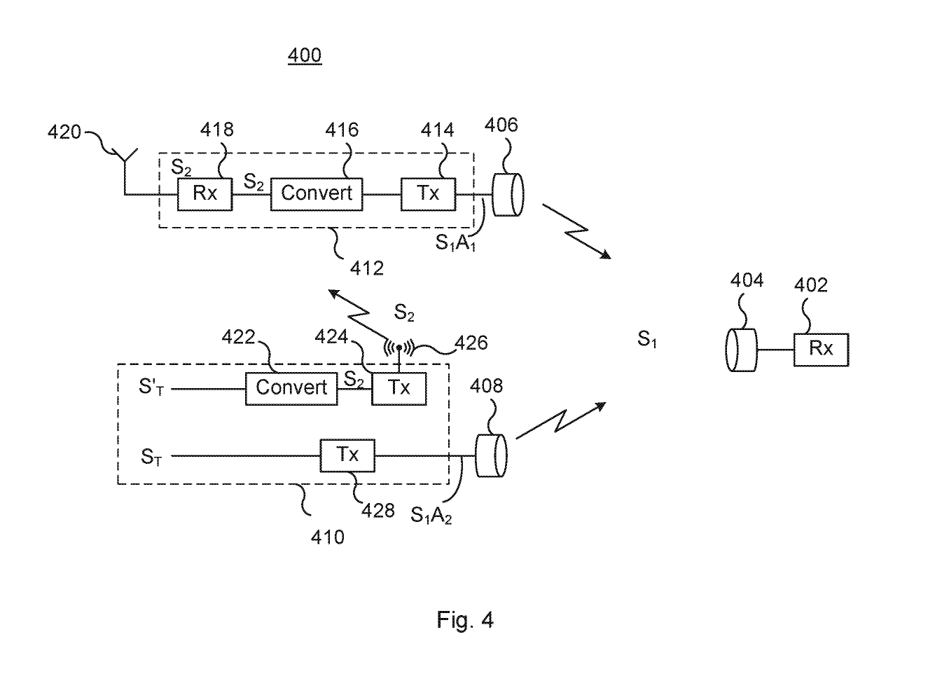

FIG. 4 is a schematic illustration of a multiple-antenna transmitter arrangement 400. In many ways, the transmitter arrangement is a reversed version of the receiver arrangement described above with reference to FIG. 1. The transmitter arrangement is configured to transmit information via a wireless signal S1 to be received by a remote receiver 402. The transmitter arrangement 400 comprises first and second spatially separated antennas 406, 408 configured to be operatively connected to a central transmitter unit 410.

Herein, as for the multiple-antenna receiver arrangements discussed in connection to FIG. 1-3, operatively connected means that an information signal may pass between antennas and the central transmitter unit. Hence, operatively connected may refer to connection by cable, or connection by part cable and part wireless link. Both options are illustrated in FIG. 4 where the first antenna 406 is operatively connected to the central transmitter unit 410 by part cable and by part wireless link, while the second antenna 408 is operatively connected to the central transmitter unit 410 by cable only.

So, the first antenna 406 is operatively connected to the central transmitter unit 410 via a first transceiver unit 412 comprising a transmitting unit 414, a signal converting unit 416, and a receiving unit 418 having a receiving o10 antenna 420. The central transmitter unit 410 is arranged to convert a signal S_{T}′ into a second signal S2 separable from the signal S1, and to transmit the second signal S2 wirelessly to the first transceiver unit 412. The first transceiver unit 412 is in turn configured to receive the second signal S2, and to convert the signal S2 into a signal S1A1, and to transmit the signal S1A1 as part of the wireless signal S1 to be received by the remote receiver 402, having at least one receiving antenna 404, via the first antenna 406. The central transmitter unit 410 is further arranged to generate a signal S1A2 from a signal S_{T}, and to transmit the signal S1A2 via the second antenna 408 as part of the wireless signal S1 via the second antenna 408 to be received by the remote receiver 402. The central transmitter unit 410 comprises a signal converting unit 422 to convert the signal S_{T}′ into S2, and a transmitter unit 424 having an antenna 426 for transmitting the signal S2 to the transceiver unit 412. The central transmitter unit 410 further comprises a second transmitter unit 428 for transmitting the signal S1A2 to the remote receiver 402.

According to aspects the signals S_{T}′ and S_{T} are equal, i.e., they are the same signal. Such aspects mainly relate to, e.g., multiple-antenna transmitter arrangements configured for transmit diversity.

According to other aspects, the signals S_{T}′ and S_{T} are different, and carry different data, i.e., they carry different information. Such aspects mainly relate to multiple-antenna transmitter arrangements configured for MIMO communication.

According to further aspects, the signals S_{T}′ and S_{T} are at least partly different but generated from the same source signal S. Such aspects relate mainly to systems employing pre-coding of antenna signals prior to transmission.

FIG. 4 thus describes a multiple-antenna transmitter arrangement 400 where a transceiver unit 412 is located spatially separated from and wirelessly communicating with central transmitter unit 410. Thereby, the advantages, effects and variations described above in relation to the multiple-antenna receiver arrangement are applicable also for the transmitter arrangement.

It is noted in FIG. 4 that the antennas 406, 408 as well as the central transmitter unit 410 are co-located in the sense that they form part of the same multiple-antenna transmitter arrangement and are deployed within a limited range of each other. Thus, the arrangement illustrated in FIG. 4 is different from a communication system where a relay transceiver has been deployed to relay transmission of signal S1 from a transmitter to a receiver. Such a communication system comprising a relay would not solve the problems considered herein.

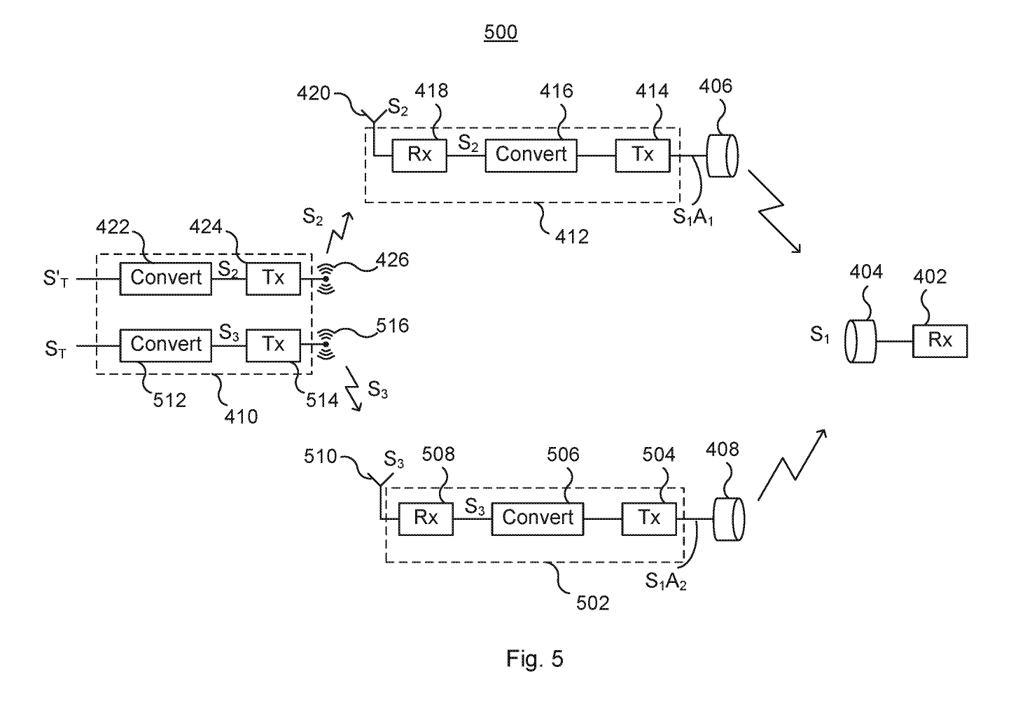

FIG. 5 schematically illustrates transmitter arrangement 500 comprising a second transceiver unit 502, similar to the first transceiver unit 412. Also the second transceiver unit 502 comprises a transmitting unit 504, a signal converting unit 506, and a receiving unit 508 having a receiving antenna 510. The central transmitter unit 410 is arranged to transmit a signal S1A2 via the second antenna 408 as part of the signal S1 to be received by the remote receiver 402 by converting a signal S_{T} into a third signal S3, using a signal converter 512, where S3 is separable both from the signal S1 and from the signal S2, and to wirelessly transmit the third signal S3 to the second transceiver unit 502. The central transmitter unit 410 comprises a transmitting unit 514 having a transmitting antenna 516 for transmitting the signal S3. The second transceiver unit 502 is thus configured to receive the third signal S3, and to convert the signal S3 into the signal S1A2, and to transmit the signal S1A2 as part of the signal S1 to the remote receiver via the second antenna 408.

The transmitter arrangement 500 of FIG. 5 operates in a similar manner as the receiver arrangement 200 of FIG. 2. Thereby, a transmitter arrangement is provided which allows flexibility in the location of the transmitting antennas 406, 408 and the central transmitter unit. Here, a digital RF digital-to-analog converter, RF-DAC, may advantageously be used in the central transmitter unit 410.

Also in the transmitter arrangements 400, 500, a signal power of transmission of the wireless signal S1 is higher than a signal power of transmission of the second signal S2 and/or the third signal S3. As discussed above, when signal S2 and/or signal S3 is transmitted at low power, the interference generated by this transmission on other receivers is reduced compared to the case where they are transmitted at full power, i.e., at the signal power of transmission of the wireless signal S1. This means that an operator of a communications system having access to a range of frequency bands can allocate frequency bands for transmission of signals like signal S2 and signal S3 several times as long as the central receiver units are spaced far enough apart. The lower the power used for transmission, the smaller the distance between central receiver units. Also, a frequency band in use for communication of information such as the wireless signal S1 may be re-used for transmission of signals like signal S2 and signal s3 as long as receiver separation is large enough.

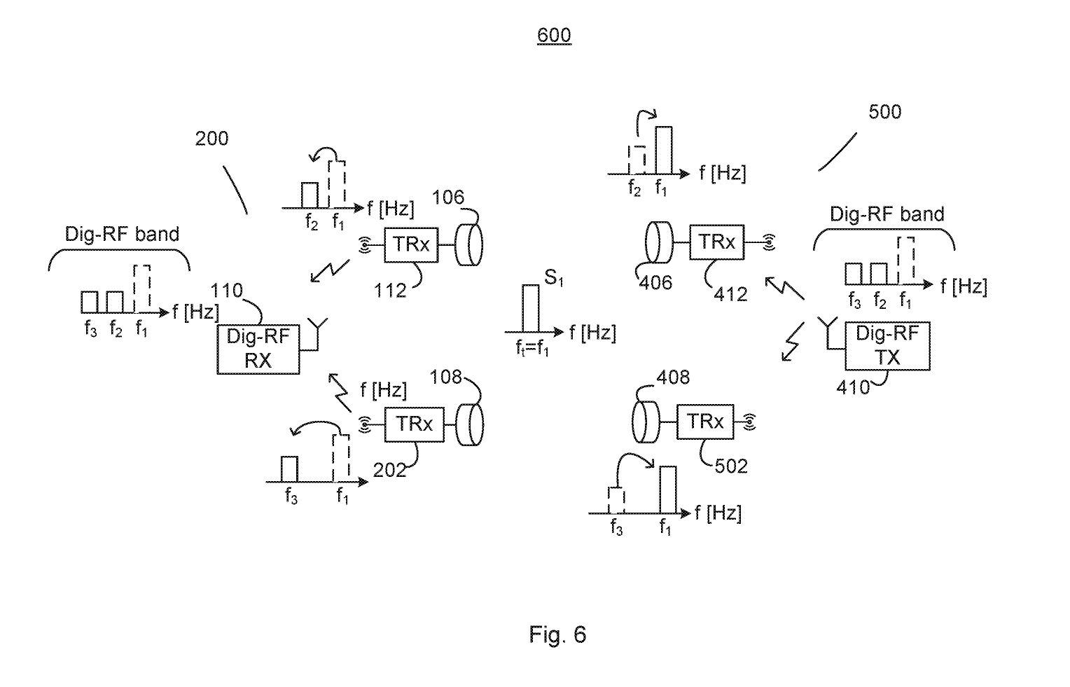

FIG. 6 is a schematic illustration of a transceiver arrangement 600 comprising a receiver arrangement 200 as discussed in relation to FIG. 2 and a transmitter arrangement 500 as discussed in relation to FIG. 5. In the transceiver arrangement 600, a multiple-input-multiple-output (MIMO) communication system is described, having the advantages describes above in relation to the various receiver and transmitter arrangements. The system can also be referred to as a LoS-MIMO system where a line-of-sight is required between the transmitting and receiving antennas.

In the example of FIG. 6, two antenna signals are generated at the central transmitter unit 410 shown to the right in FIG. 6. One such antenna signal is converted into a signal occupying frequency band f2 and transmitted to a transceiver 412 connected to the first transmit antenna 406. The other antenna signal is converted into a signal occupying frequency band f3 and transmitted to a transceiver 502 connected to the second transmit antenna 408. Both transceivers 412, 502 convert received signals into a signal S1 occupying frequency band f1, which is the frequency band ft of transmission to the receiving end, shown to the left in FIG. 6.

Thus, transmission of a MIMO signal from two transmit antennas is achieved without having cables between the central transmitter unit 410 and the spatially separated antennas 406, 408.

The signal S1 is received at first o16 and second o18 receive antennas. Each receive antenna is connected to a corresponding transceiver unit 112, 202. The transceiver units convert the received signal into signals occupying frequency bands f2 and f3, which signals are transmitted to the central receiver unit 110. Now, since the signals received at the two receive antennas become available at the central receiver unit, it is possible to obtain the information transmitted from the transmitter by using known MIMO signal processing techniques.

Note that, in the example of FIG. 6, frequency bands f2 and f3 are re-used at left and right hand side, i.e., at the transmitter arrangement and at the receiver arrangement. This re-use is facilitated by the above-mentioned low power transmission. Should signals to and from the transceiver units 112, 202, 412, 502 be transmitted at high power, they would have caused interference to this and other neighboring systems.

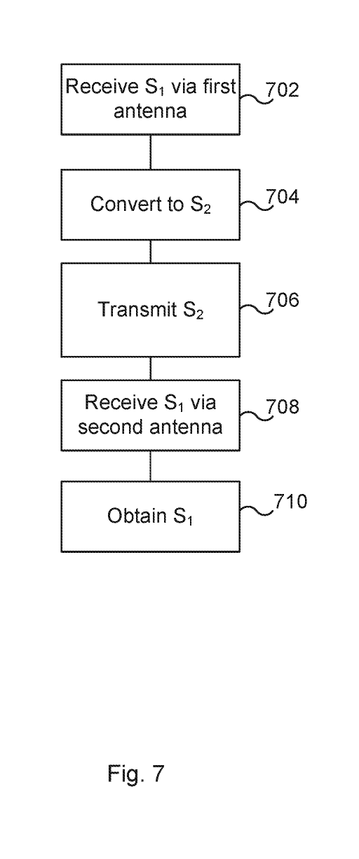

FIG. 7 is a flow chart outlining the general steps of a method for transmission in a multiple-antenna receiver arrangement according to an embodiment of the present technique. With additional reference to FIG. 1, the method can generally be described as receiving 702, by a first antenna 106 in a first transceiver unit 112, a first signal S1 transmitted from a remote transmitter 106, converting 704 the received signal S1 into a second signal S2 separable from the first received signal S1; wirelessly transmitting 706 the second signal S2 to a central receiver unit 110; receiving 708, by a second antenna 108 in the central receiver unit 110, a first signal S1 transmitted from a remote transmitter 106; and in the central receiver unit 110, obtaining 710 information comprised in S1 based on the signals received via the first and second antennas 104, 106.

According to an aspect of the method, the step of converting 704 comprises frequency shifting the first received signal S1 occupying a first frequency band f1 such that the signal S2 occupies a second frequency band f2 which is non-overlapping in frequency with the first frequency band f1.

According to an aspect of the method, the step of converting 704 comprises changing a frequency spreading code of the first received signal S1 into a frequency spreading code for the second signal S2 different from the frequency spreading code of the first signal S1.

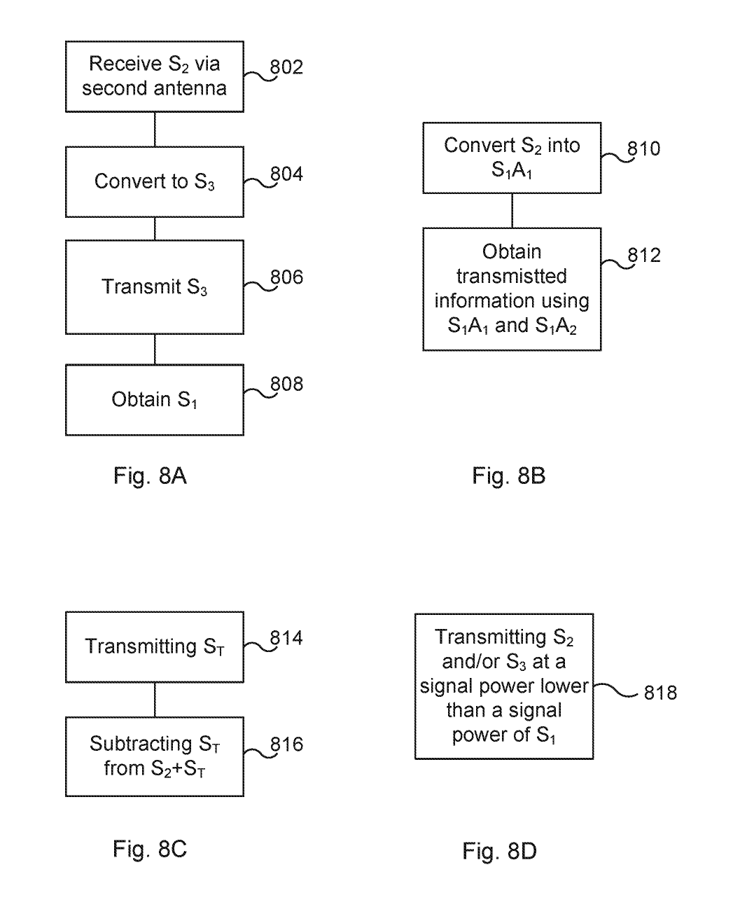

FIGS. 8A-D are flow charts outlining the general steps of methods according to various aspects of the present technique. The illustrated method steps of FIGS. 8A-D are steps to be performed in combination with the method discussed in relation to FIG. 7.

As exemplified by FIG. 8A, the method further comprises receiving 802, by a second antenna 108 being configured to be operatively connected to the central receiver unit 110 via a second transceiver unit 202, the signal S1, converting 804 the received signal into a third signal S3 separable from the received signal S1 and from the second signal S2, and transmitting 806 the third signal S3 wirelessly to the central receiver unit 110.

FIG. 8B outlines a method further comprising converting 808, in the receiver unit 110, the second signal S2 into a signal S1A1 corresponding to the signal S1 received via the first antenna 104 and obtaining 810 the transmitted information using the signal S1A1 and the signal S1 received via the second antenna 106, S1A2.

FIG. 8C outlines a method further comprising transmitting 814, by a transmission unit 302 co-located with the central receiver unit 310, a signal S_{T} to a remote receiver; and in the central receiver unit 310, subtracting 816 the signal S_{T} from the received signal S2. The signal S_{T} is transmitted in an at least partly overlapping frequency band as the signal S2.

FIG. 8D outlines a method further comprising transmitting 818 the second signal S2 and/or the third signal S3 at a signal power lower than a signal power of the wireless signal S1.

The methods disclosed herein all display advantages corresponding to the advantages of the corresponding features already mentioned in relation to the receiver and transmitter arrangements above.

Furthermore, even though the above described method is related to receiving a signal from a remote transmitter, the various embodiments of the method are equally applicable for transmitting a signal to a remote receiver, mutatis mutandis.

There is also provided a computer program comprising computer program code which, when executed in a node of a communication system, causes the communication system to execute a method according to any of the above described embodiments.

There is also provided a multiple-antenna receiver arrangement 100 for a wireless communication system. The receiver arrangement comprises means for receiving, by a first antenna 106 in a first transceiver unit 112, a first signal S1 transmitted from a remote transmitter 106, means for converting the received signal S1 into a second signal S2 separable from the first received signal S1; means for wirelessly transmitting the second signal S2 to a central receiver unit 110. The receiver arrangement further comprises means for receiving, by a second antenna 108 in the central receiver unit 110, a first signal S1 transmitted from a remote transmitter 106, and in the central receiver unit 110, means for obtaining information comprised in S1 based on the signals received via the first and second antennas 104, 106.

Even though the invention has been described with reference to specific exemplifying embodiments thereof, many different alterations, modifications and the like will become apparent for those skilled in the art from a study of the drawings, the disclosure, and the appended claims. Also, it should be noted that parts of the transmitter and receiver arrangements may be omitted, interchanged or arranged in various ways, the systems yet being able to perform the functionality of the present invention. The mere fact that certain measures are recited in mutually different dependent claims does not indicate that a combination of these measured cannot be used to advantage. Additionally, variations to the disclosed embodiments can be understood and effected by the skilled person in practicing the claimed invention, In the claims, the word “comprising” does not exclude other elements or steps, and the indefinite article “a” or “an” does not exclude a plurality.

1. A multiple-antenna receiver arrangement for receiving information from a remote transmitter via a wireless signal S1, the receiver arrangement comprising first and second spatially separated antennas configured to be operatively connected to a central receiver unit,
the first antenna being configured to be operatively connected to the central receiver unit via a first transceiver unit,
the first transceiver unit being configured to receive the signal S1 via the first antenna, and to convert the received signal into a second signal S2 separable from the received signal S1, and to transmit the second signal S2 wirelessly to the central receiver unit, and
the central receiver unit being configured to receive the signal S1 via the second antenna, and to receive the second signal S2 from the first transceiver unit, and to obtain information comprised in S1 based on the signals received via the first and second antennas.

2. The receiver arrangement according to claim 1 further comprising a second transceiver unit,
the second antenna being configured to be operatively connected to the central receiver unit via the second transceiver unit, the second transceiver unit being configured to receive the signal S1 via the second antenna, and to convert the received signal into a third signal S3 separable from the received signal S1 and from the second signal S2, and to transmit the third signal S3 wirelessly to the central receiver unit.

3. The receiver arrangement according to claim 1, wherein the central receiver unit is further configured to:
convert the second signal S2 into a signal S1A1 corresponding to the signal S1 received via the first antenna; and
obtain the transmitted information using the signal S1A1 and the signal S1 received via the second antenna, S1A2.

4. The receiver arrangement according to claim 1, wherein said central receiver unit further comprises a third receiving antenna for receiving the second signal S2.

5. The receiver arrangement according to claim 1, wherein the second receiving antenna and the third receiving antenna are integrated into a single antenna.

6. The receiver arrangement according to claim 1, wherein the central receiver unit is co-located with a transmission unit configured to transmit a signal S_{T} to a remote receiver, and wherein said central receiver unit is configured to subtract said signal S_{T} from a received signal S2+S_{T}, and wherein the signal S_{T} is transmitted in an at least partly overlapping frequency band as the signal S2.

7. The receiver arrangement according to claim 1, wherein a signal power of transmission of the second signal S2 and/or the third signal S3 is lower than a signal power of transmission of the wireless signal S1.

8. The receiver arrangement according to claim 1, wherein a distance between said first antenna and said second antenna is selected for diversity reception based on a wavelength of a carrier of said first transmitted signal S1.

9. The receiver arrangement according to claim 1, wherein said first transceiver unit comprises a signal converter configured to convert said first signal S1 occupying a first frequency band f1 into a second signal S2 occupying a second frequency band f2, wherein said first frequency band f1 and said second frequency band f2 are non-overlapping in frequency.

10. The receiver arrangement according to claim 1, wherein said first transceiver unit comprises a signal converter configured to convert said first signal S1 into a second signal S2 having a frequency spreading code different from a frequency spreading code of said first signal.

11. A multiple-antenna transmitter arrangement for transmitting information via a wireless first signal S1 to be received by a remote receiver, the transmitter arrangement comprising first and second spatially separated antennas configured to be operatively connected to a central transmitter unit,
the first antenna being operatively connected to the central transmitter unit via a first transceiver unit,
the central transmitter unit being arranged to convert a signal S_{T′} into a second signal S2 separable from the signal S1, and to transmit the second signal S2 wirelessly to the first transceiver unit,
the first transceiver unit being configured to receive the second signal S2, and to convert the signal S2 into a signal S1A1, and to transmit the signal as part of the wireless signal S1 to be received by the remote receiver via the first antenna, and
the central transmitter unit further being arranged to generate a signal S1A2 from a signal S_{T} and to transmit the signal S_{T} as part of the wireless signal S1 via the second antenna to be received by the remote receiver.

12. The transmitter arrangement according to claim 11 further comprising a second transceiver unit,
the central transmitter unit being arranged to transmit a signal S1A2 via the second antenna as part of the signal S1 to be received by the remote receiver by converting the signal S_{T} into a third signal S3 separable from the signal S1 and from the signal S2, and to wirelessly transmit the third signal S3 to the second transceiver unit, and
the second transceiver unit being configured to receive the third signal S3, and to convert the signal S3 into the signal S1A2, and to transmit the signal S1A2 as part of the wireless signal S1 to be received by the remote receiver via the second antenna.

13. The transmitter arrangement according to claim 11, wherein a signal power of transmission of the wireless signal S1 is higher than a signal power of transmission of the second signal S2 and/or the third signal S3.

14. A method for transmission in a multiple-antenna receiver arrangement for a wireless communication system comprising:
receiving, by a first antenna in a first transceiver unit, a first signal S1 transmitted from a remote transmitter,
converting the received signal S1 into a second signal S2 separable from said first received signal S1;
wirelessly transmitting said second signal S2 to a central receiver unit;
receiving, by a second antenna in the central receiver unit, a first signal S1 transmitted from a remote transmitter; and
in the central receiver unit, obtaining information comprised in S1 based on the signals received via the first and second antennas.

15. The method according to claim 14, further comprising:
receiving, by a second antenna being configured to be operatively connected to the central receiver unit via a second transceiver unit, the signal S1;
converting the received signal into a third signal S3 separable from the received signal S1 and from the second signal S2, and transmitting the third signal S3 wirelessly to the central receiver unit.

16. The method according to claim 14, further comprising:
converting, in said receiver unit, the second signal S2 into a signal S1A1 corresponding to the signal S1 received via the first antenna; and
obtaining the transmitted information using the signal S1A1 and the signal S1 received via the second antenna, S1A2.

17. The method according to claim 14, further comprising:
transmitting, by a transmission unit co-located with the central receiver unit, a signal S_{T} to a remote receiver; and
in said central receiver unit, subtracting said signal S_{T} from said received signal S2, and wherein the signal S_{T} is transmitted in an at least partly overlapping frequency band as the signal S2.

18. The method according to claim 14, further comprising transmitting the second signal S2 and/or the third signal S3 at a signal power lower than a signal power of the wireless signal S1.

19. The method according to claim 14, wherein said step of converting comprises frequency shifting said first received signal S1 occupying a first frequency band f1 such that said signal S2 occupies a second frequency band f2 which is non-overlapping in frequency with said first frequency band f1.

20. The method according to claim 14, wherein said step of converting comprises changing a frequency spreading code of said first received signal S1 into a frequency spreading code for said second signal S2 different from the frequency spreading code of said first signal S1.

21. A computer program product comprising a non-transitory computer readable medium storing computer program code which, when executed by at least one processor in a node of a communication system, causes the communication system to execute the method according to claim 14.

22. A multiple-antenna receiver arrangement for a wireless communication system comprising:
means for receiving, by a first antenna in a first transceiver unit, a first signal S1 transmitted from a remote transmitter,
means for converting the received signal S1 into a second signal S2 separable from said first received signal S1;
means for wirelessly transmitting said second signal S2 to a central receiver unit;
means for receiving, by a second antenna in the central receiver unit, a first signal S1 transmitted from a remote transmitter; and
in the central receiver unit, means for obtaining information comprised in S1 based on the signals received via the first and second antennas.

23. (canceled)
